(19) United States
(12) Patent Application Publication
(10) Pub. No.: US 2017/0117067 A1
(43) Pub. Date: Apr. 27, 2017

(54) METHOD FOR REPAIRING ELECTRICALLY EROSIVE POT HOLE ON SURFACE OF LIQUID SILICONE RUBBER SHED

(71) Applicants: Graduate School at Shenzhen, Tsinghua University, Shenzhen (CN); Electric Power Research Institute of State Grid Ningxia Electric Power Company, Yinchuan (CN)

(72) Inventors: Zhidong JIA, Shenzhen (CN); Weian YE, Shenzhen (CN); Yishan LI, Shenzhen (CN); Shitao LIU, Yinchuan (CN); Fei GUO, Yinchuan (CN); Xutao WU, Yinchuan (CN); Junlu CHE, Yinchuan (CN); Cunxi BAI, Yinchuan (CN); Bo WU, Yinchuan (CN); Bin CHANG, Yinchuan (CN); Xiuguang LI, Yinchuan (CN); Jinpeng HAO, Yinchuan (CN)

(21) Appl. No.: 15/388,713

(22) Filed: Dec. 22, 2016

Related U.S. Application Data
(63) Continuation of application No. PCT/CN2015/099508, filed on Dec. 29, 2015.

(30) Foreign Application Priority Data
Oct. 27, 2015 (CN) 201510705359.3

(51) Int. Cl. H01B 3/46; B05D 5/00; H01B 19/04; B05D 3/00

(52) U.S. Cl. CPC H01B 3/46; B05D 3/002; B05D 5/005; H01B 19/04

(57) ABSTRACT

Disclosed is a method for repairing an electrically erosive pot hole on a surface of a liquid silicone rubber (LSR) shed, including the following steps: using RTV anti-pollution flashover paint as a first coating, and coating the RTV anti-pollution flashover paint on a surface of an electrically erosive pot hole to make the surface of the pot hole smooth; using a mono-component RTV repair adhesive as a second coating to fill the electrically erosive pot hole, so as to fill and level up the electrically erosive pot hole, and the mono-component RTV repair adhesive is closely bonded to the first coating; and using the RTV anti-pollution flashover paint as a third coating, and coating the RTV anti-pollution flashover paint on the second coating. The method enables the appearance and performance of an LSR shed on which electrical erosion occurs to be effectively recovered.

### BACKGROUND

Technical Field

The present application relates to a method for repairing an electrically erosive pot hole on a surface of a liquid silicone rubber (LSR) shed.

Related Art

Silicone rubber composite insulating materials are currently widely applied in a power grid due to the outstanding weather fastness, tracking and erosion resistance performance, and the good electrical insulation performance. There are mainly three types of silicone rubber insulating materials used in a power grid home and broad: high temperature vulcanized silicone rubber (HTV), room temperature vulcanized silicone rubber (RTV), and LSR (also called medium temperature vulcanized silicone rubber).

Chinese power system begun to use silicone rubber as an insulating material since 1980s, and typical applications are silicone rubber composite insulators and RTV anti-pollution flashover paint, and LSR used on a sheath and a post insulator. Composite insulating materials effectively improves anti-pollution flashover capabilities of the power grid.

In the silicone rubber composite insulating materials, LSR has advantages of good flowability, low viscosity, simple process, and fast shaping in addition to good electrical performance, heat and cold resistance, and arc resistance. Therefore, the LSR is widely applied to external insulating sheaths. However, obvious and severe aging phenomena occur on LSR shed of inductors that run in some regions. In particular, in highly polluted regions, because of some conducting pollution attached on a surface of LSR, local electric field distortion is caused; spark-shaped discharge or fire arc ablation is generated on a surface of the shed, thereby generating the electrically erosive pot hole. The generation of the electrically erosive pot hole severely affects secure running of electrical devices, and the running reliability is doubted.

The repair of the electrically erosive pot hole is performed with the aim of repairing physical performance and electrical performance of the surface of the LSR shed after electrical erosion occurs on the surface of the LSR shed, which is different from secondary coating after materials are aged.

### SUMMARY

A main object of the present application lies in providing a method for repairing an electrically erosive pot hole on a surface of an LSR shed, so as to enable the appearance and performance of an LSR shed on which electrical erosion occurs to be recovered.

To achieve the foregoing object, the present application uses the following technical solutions:

a method for repairing an electrically erosive pot hole on a surface of an LSR shed, including the following steps:

using RTV anti-pollution flashover paint as a first coating, and coating the RTV anti-pollution flashover paint on a surface of an electrically erosive pot hole to make the surface of the pot hole smooth;

using a mono-component RTV repair adhesive as a second coating to fill the electrically erosive pot hole, so as to fill and level up the electrically erosive pot hole, and the mono-component RTV repair adhesive is closely bonded to the first coating; and

using the RTV anti-pollution flashover paint as a third coating, and coating the RTV anti-pollution flashover paint on the second coating.

Further:

the RTV anti-pollution flashover paint used as the first coating and/or the second coating satisfies standard DL/T 627-2012.

the mono-component RTV repair adhesive has the following performance:

a tensile strength (MPa) is greater than or equal to 2.0;

a relative elongation percentage (%) is greater than or equal to 200;

a hardness (HA) is greater than or equal to 20; and

an electric strength (MV/m) is greater than or equal to 17.

Before the first coating is coated, the electrically erosive pot hole is polished and cleaned.

The polishing includes polishing a periphery of the electrically erosive pot hole to make an interface of the periphery of the electrically erosive pot hole smooth.

A process of filling the electrically erosive pot hole by using the mono-component RTV repair adhesive includes: uniformly applying the repair adhesive until a surface of the second coating is smooth and is flush with the surface of the shed.

Beneficial effects of the present application:

the method of the present application can effectively repair a pot hole generated after electric erosion occurs on a surface of a shed made of LSR; the present method considers a damaged condition of a surface of the electrically erosive pot hole and factors such as physical performance and electrical performance on the surface of the shed.

The method of present application is particularly suitable for repairing a superficial-layer electrically erosive pot hole. Repairing the shed by using the method has high quality and strong reliability. The hydrophobicity, and tracking and erosion resistance performance of the LSR shed repaired by using the present method may reach the level before electrical erosion occurs.

### BRIEF DESCRIPTION OF THE DRAWINGS

FIG. 1 is a flowchart of a specific embodiment of the present application;

FIG. 2 is a design sketch of a superficial-layer electrically erosive pot hole before repair;

FIG. 3 is a design sketch after repair adhesive is filled according to a repair method of an embodiment of the present application; and

FIG. 4 is a design sketch after repair is completed according to a repair method of an embodiment of the present application.

### DETAILED DESCRIPTION

The following describes implementation manners of the present application in detail. It should be emphasized that the following description is merely exemplary, and is not intended to limit the scope and applications of the present application.

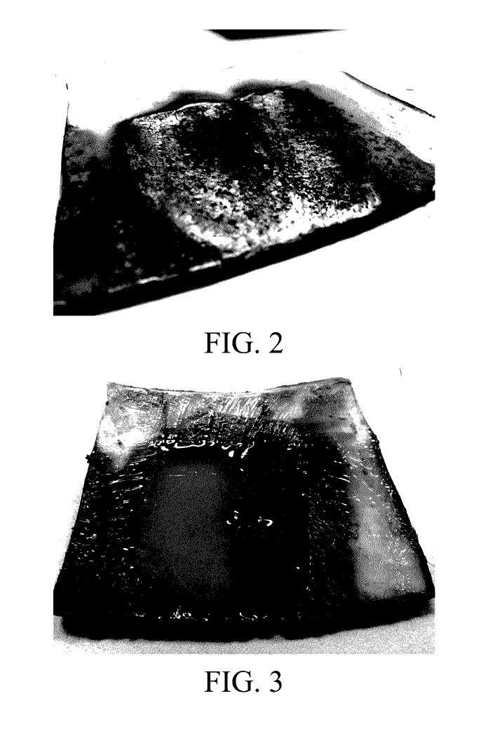

With reference to FIG. 2, a superficial-layer electrical erosive condition on a surface of LSR generally has the following characteristics: (1) a depth is within 5 mm; (2) a surface is rough, and has obvious ablation traces; and (3) easily to attach pollution and cause further ablation.

In an embodiment, a repair method of the present application includes the following several steps:

(1) before repair, an electrically erosive pot hole that needs to be repaired is polished and cleaned to make a surface condition suitable to be repaired;

(2) performance of a repair interface is improved by using RTV anti-pollution flashover paint to make the repair interface even and smooth and inhibit generation of air bubbles; RTV anti-pollution flashover paint that satisfies standard DL/T 627-2012 is preferably used as a first coating to make the surface of the pot hole smooth and bonded securely, thereby solving the problem that air bubbles generated at the interface after being repaired directly using a subsequent repair adhesive;

(3) the pot hole is filled by using a high-viscosity repair adhesive in mono-component RTV, and the technical performance of the repair adhesive satisfies the technical performance shown in Table 1; a mono-component RTV repair adhesive is used as a second coating to fill the electrically erosive pot hole; the mono-component RTV repair adhesive has good bonding performance and high solid content. problems such as recesses and protrusions do not occur after filling, and the mono-component RTV repair adhesive can be closely bonded to the RTV on a previous layer;

superficial-layer electrical erosion is merely generating a concave pot hole on a silicone rubber shed instead of a pot hole that penetrates through the shed the repair adhesive applied in repairing has moderate flowability, high viscosity, high solid content, and is suitable for repairing defects of silicone rubber; the technical performance of the repair adhesive is shown in Table 1:

TABLE 1
technical performance of RTV repair adhesive

| Appearance | White paste |
|---|---|
| Tensile strength (MPa) | ≧2.0 |
| Relative elongation percentage (%) | ≧200 |
| Hardness (HA) | ≧20 |
| Electric strength (MV/m) | ≧17 |

(4) the RTV anti-pollution flashover paint is used to improve the hydrophobicity, and the tracking and erosion resistance of the surface of the LSR shed; the RTV anti-pollution flashover paint that satisfies standard DL/T 627-2012 is used as a third coating, with the function of increasing the hydrophobicity, and improving the tracking and erosion resistance of the surface, so that after repair, the hydrophobicity performance can reach level HC1, and the tracking and erosion resistance performance can reach level TMA3.5.

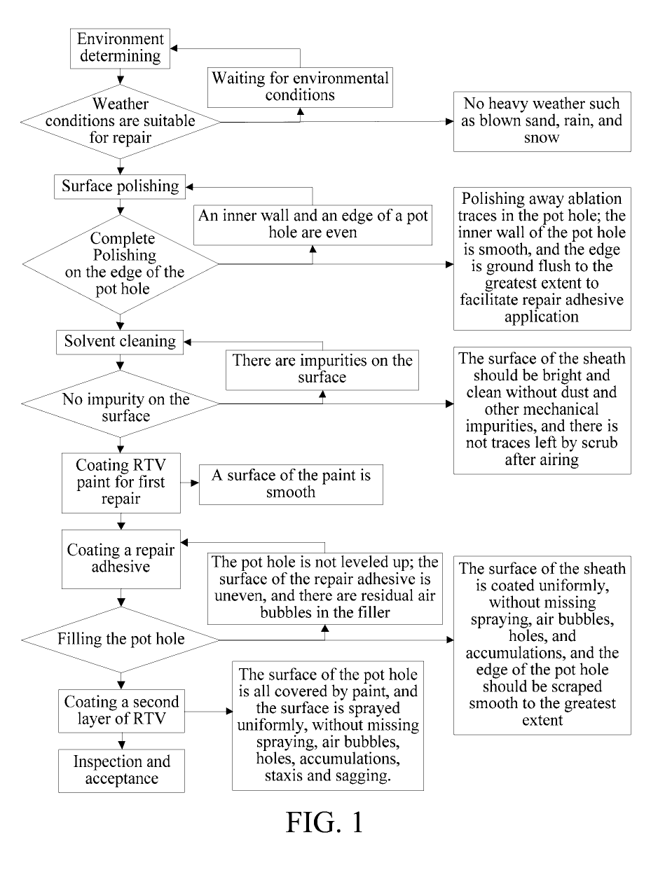

In the specific example shown in FIG. 1, a repair process may proceed according to the following steps:

(1) Environmental Factor Determining

silicone rubber repair should be operated in weather without blown sand, rain, and snow, and repair is not repaired temporarily if environmental factors do not allow;

(2) Pot Hole Polishing

a surface of the erosive pot hole is rough and uneven with large amount of erosive traces and dust; a polisher is used to posh a periphery of the pot hole to make an interface of the periphery of the pot hole smooth;

(3) Surface Cleaning

a solvent such as absolute ethyl alcohol is used to clean dust in the pot hole, including original accumulated pollution in the ablated pot hole and residual dust in a polishing process; if there is a large amount of accumulated pollution, the accumulation pollution can be scrubbed for many times, so as to ensure cleanliness before repair;

(4) Spraying a First Layer of RTV Anti-Pollution Flashover Paint

after the solvent on the surface is volatilized, a first layer of RTV anti-pollution flashover paint is sprayed; during spraying, the pot hole and the periphery thereof should be uniformly sprayed until the paint completely covers the surface of the pot hole; the RTV anti-pollution flashover paint should satisfy standard DL/T 627-2012;

(5) Filling the Repair Adhesive

after the first layer of RTV anti-pollution flashover paint is solidified in 24h, the repair adhesive is uniformly applied in the pot hole; a putty knife is used to uniformly apply the repair adhesive until the surface is the repair adhesive is even and is flush with the shed;

(6) Coating a Second Layer of RTV Anti-Pollution Flashover Paint

after the repair adhesive is solidified in 24h, a repaired part is examined; if there is not air bubble on the repair interface, and when the shed part is broken by hands, the interface is bonded securely, and cracking does not occur, the second layer of RTV anti-pollution flashover paint is coated, and the RTV anti-pollution flashover paint should satisfy standard DL/T 627-2012; if the interface is bonded insecurely, the repair adhesive is scraped off by using a blade, and step (1) is returned to for re-repair; and

(7) Inspection and Acceptance

after the second layer of RTV paint is solidified, the shed is broken by hands, and if there is no crack on the surface, and bonding between two layers of paint is close, and there is no coating-detachment phenomenon, inspection and acceptance succeed; if the inspection and acceptance does not succeed, the RTV repair adhesive is scraped off by using a blade, and step (1) is returned to for re-repair.

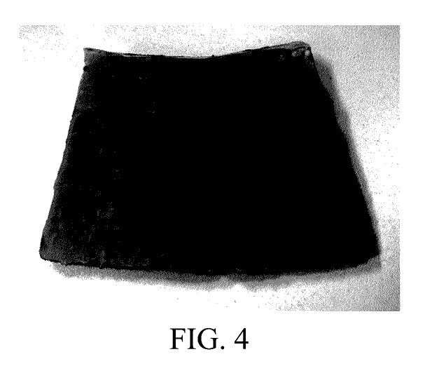

See FIG. 2 to FIG. 4 for effect contrast before and after repair. The GD-442 mono-component RTV of China BlueStar Chenguand is used as the repair adhesive, and Powersil of Wack is used as the anti-pollution flashover paint; after repair, the hydrophobicity is level HC1 upon test, and a test result of the tracking and erosion resistance upon an inclined plane test is level TMA3.5, which is similar to the performance of the LSR before electrical erosion.

The foregoing content is further detailed description made to the present application with reference to specific/preferable implementation manners, and specific implementation of the present application cannot be determined to be limited only to the description. For a person of ordinary skill in the art to which the present application belongs, on a precondition of not departing from a conception of the present application, he/she may further make several replacements or modifications on the described implementation manners, and the replacement or modification manners should be considered to belong to the protection scope of the present application.

What is claimed is:

1. A method for repairing an electrically erosive pot hole on a surface of a liquid silicone rubber (LSR) shed, comprising the following steps:
using RTV anti-pollution flashover paint as a first coating, and coating the RTV anti-pollution flashover paint on a surface of an electrically erosive pot hole to make the surface of the pot hole smooth;
using a mono-component RTV repair adhesive as a second coating to fill the electrically erosive pot hole, so as to fill and level up the electrically erosive pot hole, and the mono-component RTV repair adhesive is closely bonded to the first coating; and
using the RTV anti-pollution flashover paint as a third coating, and coating the RTV anti-pollution flashover paint on the second coating.

2. The method according to claim 1, wherein the RTV anti-pollution flashover paint used as the first coating and/or the second coating satisfies standard DL/T 627-2012.

3. The method according to claim 1, wherein the mono-component RTV repair adhesive has the following performance:
a tensile strength (MPa) is greater than or equal to 2.0;
a relative elongation percentage (%) is greater than or equal to 200;
a hardness (HA) is greater than or equal to 20; and
an electric strength (MV/m) is greater than or equal to 17.

4. The method according to claim 1, wherein: before the first coating is coated, the electrically erosive pot hole is polished and cleaned.

5. The method according to claim 2, wherein: before the first coating is coated, the electrically erosive pot hole is polished and cleaned.

6. The method according to claim 3, wherein: before the first coating is coated, the electrically erosive pot hole is polished and cleaned.

7. The method according to claim 4, wherein the polishing comprises polishing a periphery of the electrically erosive pot hole to make an interface of the periphery of the electrically erosive pot hole smooth.

8. The method according to claim 5, wherein the polishing comprises polishing a periphery of the electrically erosive pot hole to make an interface of the periphery of the electrically erosive pot hole smooth.

9. The method according to claim 6, wherein the polishing comprises polishing a periphery of the electrically erosive pot hole to make an interface of the periphery of the electrically erosive pot hole smooth.

10. The method according to claim 1, wherein: a process of filling the electrically erosive pot hole by using the mono-component RTV repair adhesive comprises: uniformly applying the repair adhesive until a surface of the second coating is smooth and is flush with the surface of the shed.

11. The method according to claim 2, wherein: a process of filling the electrically erosive pot hole by using the mono-component RTV repair adhesive comprises: uniformly applying the repair adhesive until a surface of the second coating is smooth and is flush with the surface of the shed.

12. The method according to claim 3, wherein: a process of filling the electrically erosive pot hole by using the mono-component RTV repair adhesive comprises: uniformly applying the repair adhesive until a surface of the second coating is smooth and is flush with the surface of the shed.

13. The method according to claim 4, wherein: a process of filling the electrically erosive pot hole by using the mono-component RTV repair adhesive comprises: uniformly applying the repair adhesive until a surface of the second coating is smooth and is flush with the surface of the shed.

14. The method according to claim 5, wherein: a process of filling the electrically erosive pot hole by using the mono-component RTV repair adhesive comprises: uniformly applying the repair adhesive until a surface of the second coating is smooth and is flush with the surface of the shed.

15. The method according to claim 6, wherein: a process of filling the electrically erosive pot hole by using the mono-component RTV repair adhesive comprises: uniformly applying the repair adhesive until a surface of the second coating is smooth and is flush with the surface of the shed.
